(19) United States
(12) Patent Application Publication
(10) Pub. No.: US 2009/0080794 A1
(43) Pub. Date: Mar. 26, 2009

(54) IMAGE PROCESSING DEVICE, MICROCOMPUTER, AND ELECTRONIC INSTRUMENT

(75) Inventor: Yoshinobu AMANO, Shimotsuma (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/233,888

(22) Filed: Sep. 19, 2008

(30) Foreign Application Priority Data
Sep. 21, 2007 (JP) 2007-245216

(51) Int. Cl. G06K 9/40

(52) U.S. Cl. 382/274

(57) ABSTRACT

An image processing device that receives pixel-unit image data in a plurality of frames in time series and performs image processing, the image data being captured by an imaging section, the image processing device including a brightness change detection section that integrates pixel values or pixel components relating to luminance of at least part of pixels of the received image data in each of the frames to calculate an integrated value, compares the integrated value with a given comparison target value, and detects a change in brightness of an image in each of the frames based on a comparison result.

Japanese Patent Application No. 2007-245216, filed on Sep. 21, 2007, is hereby incorporated by reference in its entirety.

### BACKGROUND OF THE INVENTION

The present invention relates to an image processing device, a microcomputer, and an electronic instrument.

An image recording device (drive recorder) has been known that is provided in a moving body (e.g., car) in order to acquire image data at the time of an accident.

As image recording device technology, technology that sequentially stores image data acquired by an imaging section in time series in a primary storage section, and, when an accident has been detected, stores the image data that has been acquired in a predetermined period before the accident and stored in the primary storage section in a secondary storage section has been known (see JP-A-5-197858). According to this technology, since the image data acquired in a predetermined period before the accident can be stored in the secondary storage section, the data that indicates the progress of the accident can be acquired.

However, the imaging conditions for an imaging section provided in a drive recorder or the like change to a large extent corresponding to the environment in which the car is situated. For example, when the car enters or leaves a tunnel, the brightness of the environment changes rapidly. Therefore, the luminance of the imaging section may not be adjusted in time so that a bright or dark image in which the object cannot be determined may be acquired.

### SUMMARY

According to a first aspect of the invention, there is provided an image processing device that receives pixel-unit image data in a plurality of frames in time series and performs image processing, the image data being captured by an imaging section, the image processing device comprising:

a brightness change detection section that integrates pixel values or pixel components relating to luminance of at least part of pixels of the received image data in each of the frames to calculate an integrated value, compares the integrated value with a given comparison target value, and detects a change in brightness of an image in each of the frames based on a comparison result.

According to a second aspect of the invention, there is provided a microcomputer comprising the above-described image processing device.

According to a third aspect of the invention, there is provided an electronic instrument comprising:

the above-described microcomputer;

an input section that inputs data to be processed by the microcomputer; and

an LCD output section that outputs the data processed by the microcomputer.

### BRIEF DESCRIPTION OF THE SEVERAL VIEWS OF THE DRAWING

FIG. 1 is a functional block diagram showing an image processing device according to one embodiment of the invention.

FIG. 2 is a diagram for describing an example of a brightness change detection method employed for a brightness change detection section according to one embodiment of the invention.

FIG. 3 is a diagram for describing a configuration example of a brightness change detection section.

FIG. 4 shows a setting example of the level of a change in brightness.

FIG. 5 is a configuration diagram showing an image data recording system 1 (drive recorder or security camera) using an image processing device according to one embodiment of the invention.

FIG. 6 is an explanatory view showing an image data recording system applied to a drive recorder.

FIG. 7 is a diagram showing a configuration example of a first image processing device (dual-camera image controller).

FIG. 8 is a diagram showing a configuration example of a second image processing device (multi-video-input interlace/progressive device or IC that converts an interlaced signal into a progressive signal) according to one embodiment of the invention.

FIG. 9 is a hardware block diagram showing a microcomputer according to one embodiment of the invention.

FIG. 10 is a block diagram showing an example of an electronic instrument including a microcomputer.

### DETAILED DESCRIPTION OF THE EMBODIMENT

The invention may provide an image processing device, a microcomputer, and an electronic instrument that can detect a change in brightness of an image and change the setting of an imaging section according to a change in brightness.

(1) According to one embodiment of the invention, there is provided an image processing device that receives pixel-unit image data in a plurality of frames in time series and performs image processing, the image data being captured by an imaging section, the image processing device comprising:

a brightness change detection section that integrates pixel values or pixel components relating to luminance of at least part of pixels of the received image data in each of the frames to calculate an integrated value, compares the integrated value with a given comparison target value, and detects a change in brightness of an image in each of the frames based on a comparison result.

The brightness change detection section may be implemented by means of hardware by providing a dedicated circuit, or may be implemented by means of software by causing a CPU to execute a brightness change detection program, for example.

The brightness change detection section may detect a change in brightness of the received image data in real time, and change the setting of the imaging parameter of the imaging section or change the image processing setting of the received image on the brightness change detection result.

According to this embodiment, since a change in brightness can be detected based on the integrated value of the pixel values, an image processing device that can detect a change in brightness of an image at high speed with a reduced processing load and change the setting of the imaging section according to a change in brightness can be provided.

(2) In this image processing device, the brightness change detection section may integrate Y components of at least part of the pixels of the received image data to calculate a Y component integrated value, compare the Y component integrated value with a given comparison target value, and detect a change in brightness of the image in each of the frames based on the comparison result.

(3) In this image processing device, the brightness change detection section may divide the image in each of the frames into a plurality of areas, integrate the pixel values or the pixel components relating to luminance of the pixels of the received image in each of the frames for each of the areas to which the pixels belong to calculate an integrated value for each of the areas, and detect a change in brightness based on the integrated value for each of the areas.

For example, when only a specific area of the image brightens due to a headlight of a car or the like, if a change in brightness is determined based on the brightness of the entire area, the image may be corrected even if the brightness of the entire imaged has not been changed. In this embodiment, since a change in brightness is detected based on the integrated value for each area, whether or not only a specific area differs in brightness to a large extent can be determined. Therefore, a change in brightness can be detected more accurately.

(4) The image processing device may further comprise:

an imaging control section that performs control for changing a parameter of the imaging section relating to an image luminance adjustment when a change in brightness has been detected.

For example, a digital camera and the like are configured so that the brightness of a digital image captured in a dark place can be adjusted by controlling the signal gain using an amplifier circuit. Therefore, when the integrated value is larger than the given comparison target value, the image recognition parameter (e.g., YUV gain) of the imaging section (camera module) may be controlled to reduce the exposure. When the integrated value is smaller than the given comparison target value, the image recognition parameter (e.g., YUV gain) of the imaging section (camera module) may be controlled to increase the exposure.

(5) The image processing device may further comprise:

an interrupt control section that generates an interrupt signal when a change in brightness has been detected.

(6) In this image processing device, the brightness change detection section may set or change the comparison target value based on integrated value historical information.

(7) In this image processing device, the brightness change detection section may set or change the comparison target value based on date information.

(8) In this image processing device,

the brightness change detection section may set different comparison target values corresponding to a plurality of levels, compare the integrated value with each of the comparison target values corresponding to the levels, and determine a level of a change in brightness based on a comparison result; and

the imaging control section may perform control for changing an image recognition parameter of the imaging section based on the determined level.

(9) In this image processing device,

the imaging control section may store a level control table, the level control table storing camera module control patterns corresponding to the levels; and

the imaging control section may perform control corresponding to a level determined based on the level control table.

(10) In this image processing device, the brightness change detection section may thin out the pixels in each of the frames according to a predetermined rule when integrating the pixel values in each of the frames, and integrate the pixel values of the remaining pixels after the thinning.

(11) According to one embodiment of the invention, there is provided a microcomputer comprising the above-described image processing device.

(12) According to one embodiment of the invention, there is provided an electronic instrument comprising:

the above-described microcomputer;

an input section that inputs data to be processed by the microcomputer; and

an LCD output section that outputs the data processed by the microcomputer.

Some embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Image Processing Device

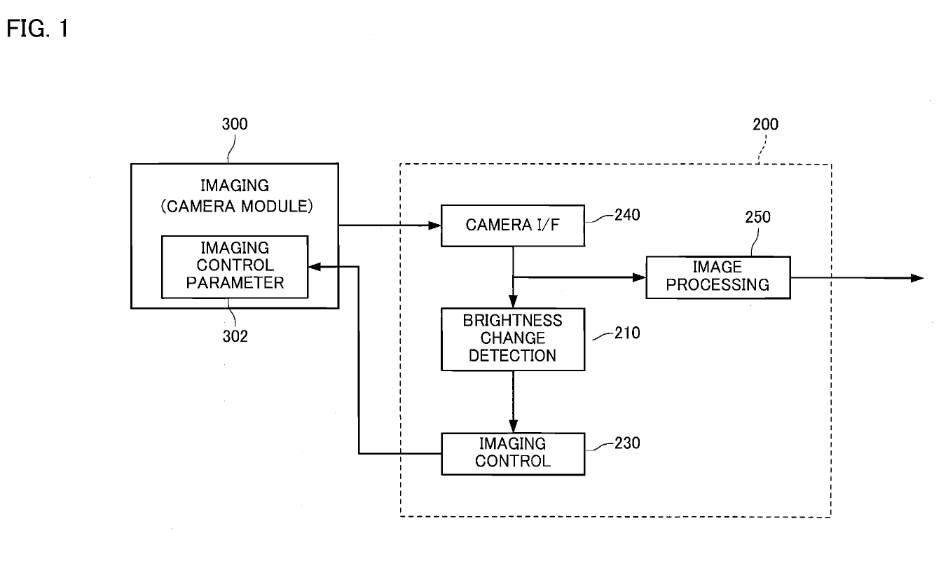

FIG. 1 is a block diagram showing an image processing device according to one embodiment of the invention.

An image processing device 200 according to this embodiment includes a camera I/F 240 that receives image data from an imaging section (camera module 300). The camera I/F 240 may receive YUV pixel data in a YUV422 format as the image data, for example.

The image processing device 200 according to this embodiment includes a brightness change detection section 210. The brightness change detection section 210 integrates pixel values or pixel components relating to luminance of at least some pixels (may be all pixels) of the received image data in each frame to calculate an integrated value (may be an integrated value for each frame, or may be an integrated value for each area in each frame), compares the integrated value with a given comparison target value, and detects a change in brightness of the image in each frame based on the comparison result.

The brightness change detection section 210 may integrate Y components of at least some pixels of the image data to calculate a Y component integrated value, compares the Y component integrated value with a given comparison target value, and detect a change in brightness of the image in each frame based on the comparison result.

The brightness change detection section 210 may divide the image in each frame into a plurality of areas, integrate pixel values or pixel components relating to luminance of the pixels of the received image in each frame for each area to which the pixels belong to calculate an integrated value corresponding to each area, and detect a change in brightness based on the integrated value for each area.

The brightness change detection section 210 may set or change the comparison target value based on integrated value historical information. For example, the brightness change detection section 210 may set the comparison target value at a large value or increase the comparison target value when the historical integrated value is large, and may set the comparison target value at a small value or decrease the comparison target value when the historical integrated value is small.

The brightness change detection section 210 may set or change the comparison target value based on date information.

The brightness change detection section 210 may set different comparison target values corresponding to a plurality of levels, compare the integrated value with the comparison target value for each level, and detect a change in brightness based on the comparison result.

The brightness change detection section 210 may thin out the pixels in each frame based on a predetermined rule when integrating the pixel values in each frame, and integrate the pixel values of the remaining pixels. For example, if the pixels are thinned out at intervals of one pixel, the pixels can be extracted evenly while reducing the processing load.

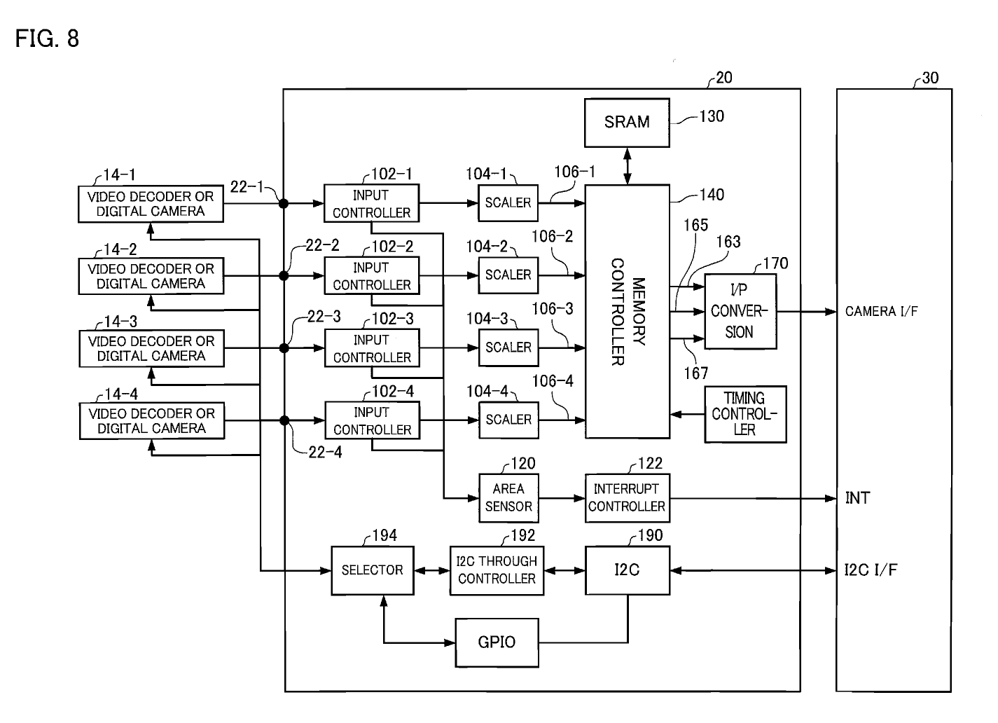

The image processing device 200 according to this embodiment may include an imaging control section 230 that changes a parameter (image recognition parameter (e.g., YUV gain)) 302 of an imaging section (camera module) 300 relating to an image luminance adjustment when a change in brightness has been detected. When the image processing device cannot directly control the imaging section 300, the imaging section (camera module) 300 may be controlled through another information processing device, as described later with reference to FIG. 8. In this case, the imaging control section 230 may function as an interrupt control section that generates an interrupt signal when a change in brightness has been detected and transmits the interrupt signal to another information processing device.

The image processing device 200 according to this embodiment includes an image processing section 250 that performs image processing according to the objective of the image processing device.

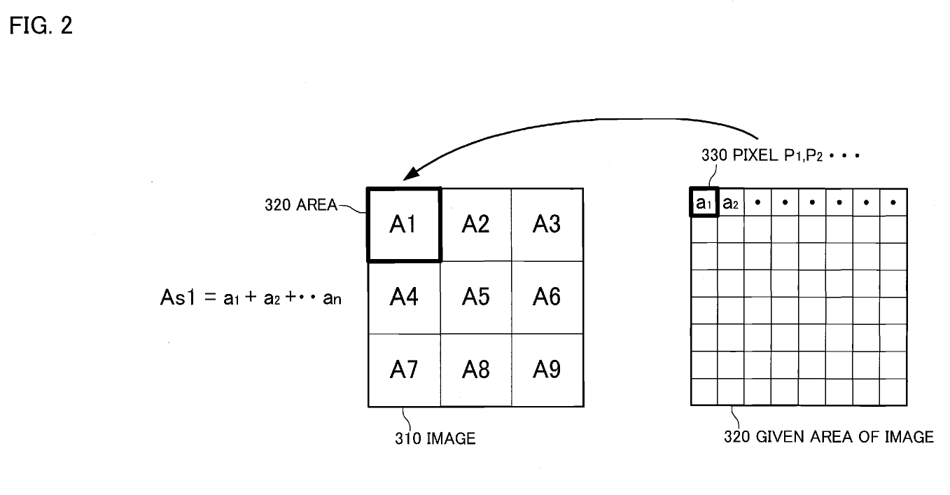

FIG. 2 is a diagram for describing an example of a brightness change detection method employed for the brightness change detection section according to this embodiment. In this embodiment, the brightness change detection section 210 divides an image into a plurality of areas, and integrates the pixel values for each area to detects a change in brightness.

Reference numeral 310 indicates an image input in time series. For example, the image may be divided into 3×3=9 areas by equally dividing the image into three areas in the horizontal direction and equally dividing the image into three areas in the vertical direction, or may be divided into M×N areas by equally dividing the image into M areas in the horizontal direction and equally dividing the image into N areas in the vertical direction.

For example, a given area 320 of the image includes m×n pixels P1, P2, . . . , Pn, and the pixel values of the pixels P1, P2, . . . , Pn are respectively a1, a2, . . . , an. The pixel values a1, a2, . . . , an may be pixel components relating to the luminance of each pixel (value of one of YUV components or RGB components), for example.

When the integrated value of the pixel values in an area A1 of the image 310 is referred to as As1, the integrated value As1 may be expressed by the following expression, for example.

As1=a1+a2+ . . . +an

An integrated value Ad1′ may be calculated by integrating values a1′, a2′, . . . , an′ of higher-order bits of the pixel values a1, a2, . . . , an.

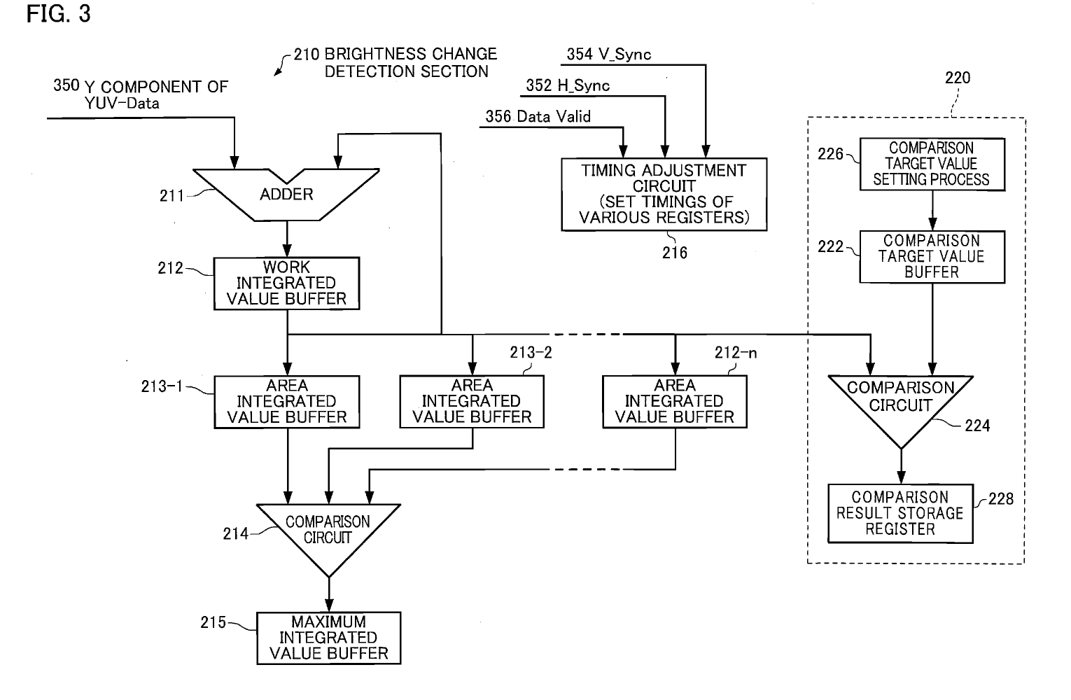

FIG. 3 is a diagram for describing a configuration example of the brightness change detection section 210.

The brightness change detection section 210 receives pixel-unit image data (e.g., YUV data 350 or RGB data, horizontal synchronization signal (HSYNC) 352, vertical synchronization signal (VSYNC) 354, and data valid signal 356) captured by the external camera module (imaging section) 300 in time series, and integrates the pixel values (or Y components) for each area in real time (in synchronization with the vertical synchronization signal (VSYNC)).

The brightness change detection section 210 may include an adder 211, a work integrated value buffer 212, area integrated value buffers 213-1 to 213-n, a comparison circuit 214, a maximum integrated value buffer 215, and a change detection section 220.

For example, the adder 211 may adds Y components of YUV data and the value stored in the work integrated value buffer to calculate an integrated value for each area, and store the integrated value corresponding to each area in an area 1 integrated value buffer 213-1, an area 2 integrated value buffer 213-2, an area 3 integrated value buffer 213-1, . . . .

The comparison circuit 214 receives the integrated values for each area stored in the area 1 integrated value buffer 213-1, the area 2 integrated value buffer 213-2, the area 3 integrated value buffer 213-1, . . . , and outputs the maximum value of the integrated values for each area of a given image to the maximum integrated value buffer 215. A value may be set in a comparison target value buffer 22 of the brightness change detection section 220 based on the value stored in the maximum integrated value buffer 215.

The brightness change detection section 220 may include a comparison target value setting section 226, a comparison target value buffer 222, a comparison circuit 224, and a comparison result storage register 228. The comparison circuit 224 receives the integrated values to be stored in the area 1 integrated value buffer 213-1, the area 2 integrated value buffer 213-2, the area 3 integrated value buffer 213-1, . . . and the value stored in the comparison target value buffer 22, and stores the comparison result in the comparison result storage register 228. For example, the comparison result storage register 228 may be a register in which a one-bit result storage area is assigned to each area, and “0” (brightness has not changed) or “1” (brightness has changed) may be stored in the result storage area based on the comparison result.

The comparison target value setting section 226 may set the comparison target value based on the integrated value historical information. For example, the comparison target value setting section 226 may set a first comparison target value in the comparison target value buffer based on the value (historical integrated value) stored in the maximum integrated value buffer 215. The maximum integrated value in the area in the preceding frame stored in the maximum integrated value buffer 215 may be set as the first comparison target value, or a value obtained from the maximum integrated value based on a predetermined rule (e.g., a value obtained by multiplying the maximum integrated value by k) may be set as the first comparison target value, for example.

The comparison target value setting section 226 may set or change the comparison target value based on the integrated value historical information. For example, the comparison target value may be set or changed based on the values stored in the maximum integrated value buffer 215 and the area integrated value buffers 213-1 to 213-9. A correspondence table or a correspondence function of each integrated value (e.g., the average value of the integrated values of the images in the preceding x frames) acquired as history and the setting value may be set, and the comparison target value may be calculated from the correspondence table or the correspondence function by means of software based on the integrated value historical information. In this case, the comparison target value may be set at a small value when the average value of the integrated values of the images in the preceding x frames is small (dark), and may be set at a large value when the average value of the integrated values is large (bright).

The comparison target value setting section 226 may set or change the comparison target value based on the date information. For example, the comparison target value setting section 226 may set the comparison target value at a small value (set a value with low luminance) in the night time zone based on the time information, and may set the comparison target value at a large value (set a value with high luminance) in the night time zone based on the time information.

When setting a plurality of levels according to a change in brightness and determining the level, a plurality of change detection sections 220 corresponding to the levels may be provided. The comparison result between the comparison target value for each level and the integrated value may be stored in a comparison result storage register for each level, and the level of a change in brightness may be determined based on the value stored in the comparison result storage register for each level.

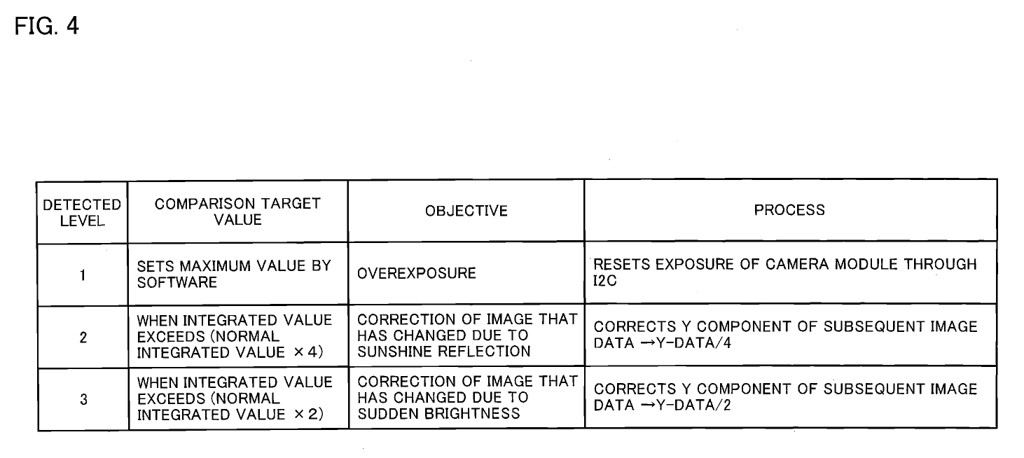

FIG. 4 shows a setting example of the level of a change in brightness.

As shown in FIG. 4, three levels (level 1 to level 3) may be set.

The level 1 is a level set to detect “overexposure”. A change at the level 1 may be detected by comparing the integrated value with the maximum pixel value. For example, the maximum pixel value may be set in the comparison target value buffer 222 of the detection section 220 for detecting the level 1. When the level 1 has been detected, the exposure of the camera module may be reset through an I2C (described later), for example.

The level 2 is a level set to “correct an image due to sunshine reflection”. A change at the level 2 may be detected by comparing the integrated value with a value four times the integrated value. For example, a default value four times the integrated value may be set in the comparison target value buffer 222 of the detection section 220 for detecting the level 2, or a value four times the value stored in the maximum integrated value buffer (history) may be set. When the level 2 has been detected, the corresponding Y component of the subsequent image data may be corrected by image processing (e.g., reduces the Y component value to ¼th of the original value).

The level 3 is a level set to “correct an image that has changed due to sudden brightness”. A change at the level 3 may be detected by comparing the integrated value with a value twice the integrated value. For example, a default value twice the integrated value may be set in the comparison target value buffer 222 of the detection section 220 for detecting the level 3, or a value twice the value stored in the maximum integrated value buffer (history) may be set. When the level 3 has been detected, the corresponding Y component of the subsequent image data may be corrected by image processing (e.g., reduces the Y component value to ½nd of the original value).

When the degree of change is set in the order of level 1>level 2>level 3, the level 1 can be detected when only the level 1 is satisfied, the level 2 can be detected when the level 1 and the level 2 are satisfied, and the level 3 can be detected when the level 1 to the level 3 are satisfied.

The image processing device generates interrupt signals that differ in type according to the level (i.e., a first interrupt signal is generated when the level 1 has been detected, a second interrupt signal is generated when the level 2 has been detected, and a third interrupt signal is generated when the level 1 has been detected), and notifies the camera module or another image processing device that can control the camera module of a change in brightness. The camera module or another image processing device that can control the camera module may set the relationship between the level of a change in brightness and the setting value of the camera module as a table in advance, acquire the setting value corresponding to the type of the received interrupt signal from the table, and set or change the imaging control parameter of the camera module based on the acquired setting value.

2. Image Data Recording System

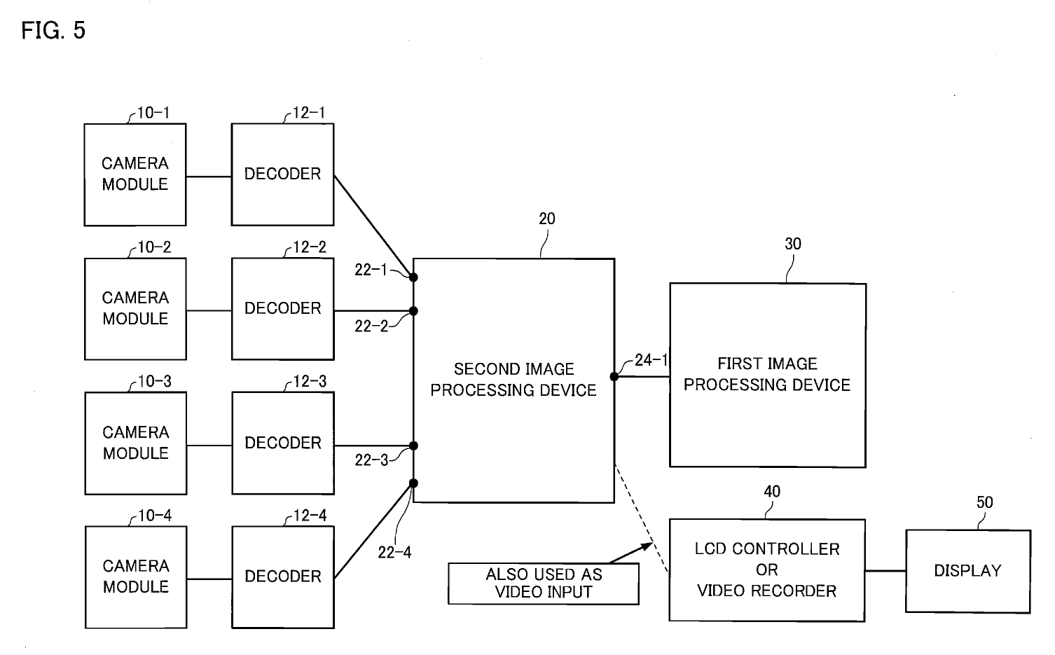

An example of an image data recording system 1 (drive recorder or security camera) using the image processing device according to this embodiment is described below with reference to FIGS. 5 to 8.

FIG. 5 is a configuration diagram showing the image data recording system 1 (drive recorder or security camera) using the image processing device according to this embodiment.

Reference numerals 10-1 to 10-4 indicate camera modules (e.g., NTSC/PAL cameras), and reference numerals 12-1 to 12-4 indicate decoders (e.g., NTSC/PAL video decoders).

Reference numeral 20 indicates a second image processing device (image processing device according to this embodiment) (multi-video-input interlace/progressive device or IC that converts an interlaced signal into a progressive signal). Digital signals from the NTSC/PAL video decoders 12-1 to 12-4 can be converted into a JPEG image by combining the second image processing device (interlace/progressive conversion device or IC) 20 with a first image processing device (multi-camera image controller) 30 and the like. The interlace/progressive conversion device 20 may include a large-capacity SRAM. Since the interlace/progressive conversion device 20 has a plurality of video input channels, the interlace/progressive conversion device 20 may perform various types of picture output (e.g., fixed picture output, auto scan picture output, and multi-input merging picture output). The second image processing device (interlace/progressive conversion device) 20 may have a moving body detection function, and the power consumption of the system may be reduced by causing the second image processing device 20 to issue an interrupt to a host CPU when the second image processing device 20 has detected a moving body.

For example, four camera sets (i.e., camera module and NTSC/PAL decoder) can be connected at a maximum by combining the second image processing device (interlace/progressive conversion device) 20 and a single camera-type image controller.

Reference numeral 30 indicates the first image processing device (dual-camera image controller) optimum for a drive recorder, an on-board camera, and the like. The first image processing device (dual-camera image controller) 30 has a camera interface function, a JPEG encoder function, a CF memory interface, an SD memory interface, a USB (device) interface, and an 8 channel ADC. A drive recorder or an on-board camera may be formed by connecting the camera modules 10-1 to 10-4, an SDRAM, an external storage (CF memory card or SD memory card), and a flash ROM which stores firmware to the first image processing device (dual-camera image controller) 30. The first image processing device (dual-camera image controller) 30 may be configured to bus.

When using the data recording system as a security camera, an output from the second image processing device (multi-video-input interlace/progressive device that converts an interlaced signal into a progressive signal) 20 may be supplied to an LCD controller or a video decoder 40 and a display 50, and displayed on the display 50.

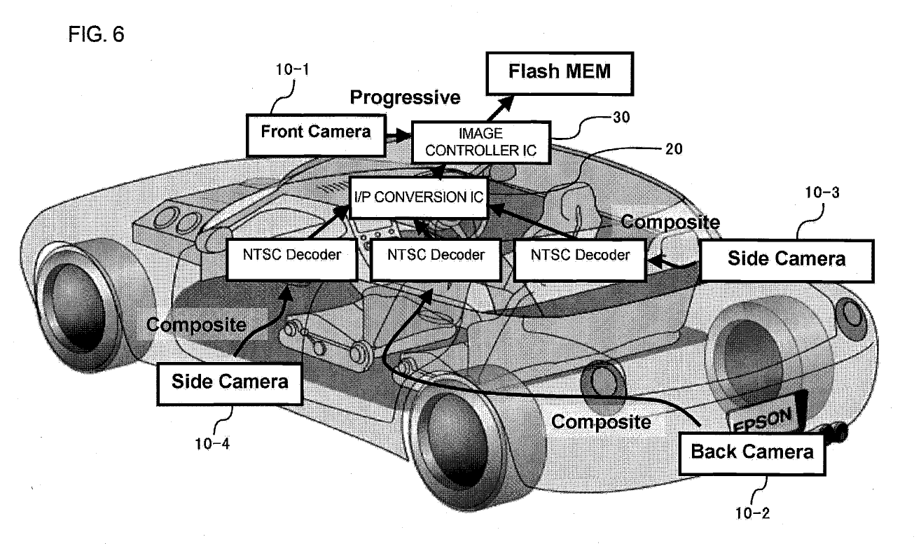

FIG. 6 is an explanatory view showing the image data recording system 1 applied to a drive recorder.

As shown in FIG. 6, the image data recording system 1 according to this embodiment includes a front camera 10-1 that photographs the front side of the vehicle body (outputs progressive digital image data), a back camera 10-2 that photographs the rear side of the vehicle body (outputs interlaced analog image data), a side camera 10-3 that photographs the left side of the vehicle body with respect to the travel direction (outputs interlaced analog image data), and a side camera 10-4 that photographs the right side of the vehicle body with respect to the travel direction (outputs interlaced analog image data).

Since the first image processing device (dual-camera image controller) 30 is a dual-camera image controller IC, the front camera 10-1 that photographs the front side of the vehicle body (outputs progressive digital image data) is connected to a first camera interface of the first image processing device (dual-camera image controller) 30, and the interlace/progressive conversion device 20 is connected to a second camera interface of the first image processing device (dual-camera image controller) 30.

Since the second image processing device (interlace/progressive conversion device) 20 has four video input channels, the back camera 10-2 that photographs the rear side of the vehicle body (outputs interlaced analog image data), the side camera 10-3 that photographs the left side of the vehicle body with respect to the travel direction (outputs interlaced analog image data), and the side camera 10-4 that photographs the right side of the vehicle body with respect to the travel direction (outputs interlaced analog image data) are connected to the video input channels through NTSC decoders.

An image photographed by the back camera 10-2, an image photographed by the side camera 10-3, and an image photographed by the side camera 10-4 can be sequentially output by causing the second image processing device (interlace/progressive conversion device) 20 to perform auto scan picture output (see FIG. 6B).

An image photographed by the back camera 10-2, an image photographed by the side camera 10-3, and an image photographed by the side camera 10-4 can be merged and output by causing the second image processing device (interlace/progressive conversion device) 20 to perform multi-input merging picture output (see FIG. 6D).

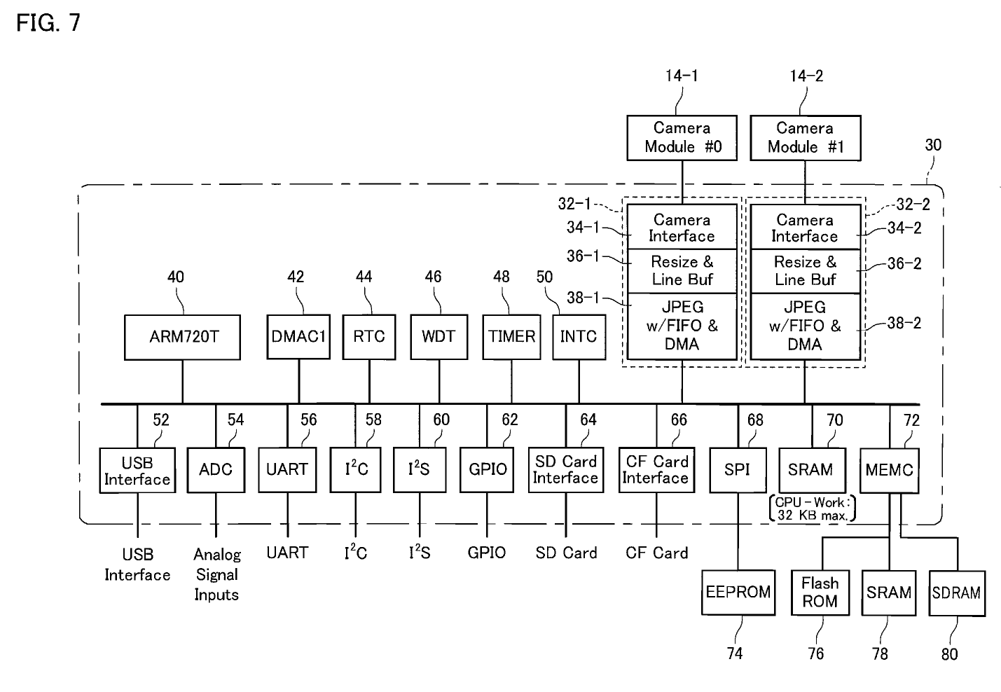

FIG. 7 is a diagram showing a configuration example of the first image processing device (dual-camera image controller).

The first image processing device (dual-camera image controller) 30 includes an image processing section 32-1 that processes image data input from a first camera module 14-1. The image processing section 32-1 includes a camera I/F 34-1, a resizing section 36-1, a compression section 38-1, and the like. The first image processing device (dual-camera image controller) 30 includes an image processing section 32-2 that processes image data input from a second camera module 14-2. The image processing section 32-2 includes a camera I/F 34-2, a resizing section 36-2, a compression section 38-2, and the like. The compression section 38-1 and the compression section 38-2 implement JPEG encoding by hardware at 30 fps@VGA.

The first image processing device (dual-camera image controller) 30 includes two hardware JPEG encoders (compression sections 38-1 and 38-2) for each of the camera modules.

The first image processing device (dual-camera image controller) 30 may

The first image processing device (dual-camera image controller) 30 may include a CF card I/F 66 for a CF memory card compliant with the CompactFlash interface standard.

The first image processing device (dual-camera image controller) 30 may include a wireless LAN interface (802.11b/g) compliant with the CompactFlash interface standard.

The first image processing device (dual-camera image controller) 30 may include an SD memory card I/F 64 for SD memory card compliant with the SD memory interface standard.

The first image processing device (dual-camera image controller) 30 includes a USB interface 52 for connection with a PC.

The first image processing device (dual-camera image controller) 30 may include an ADC 54 which can be connected to various analog sensors such as a gyrosensor.

The first image processing device (dual-camera image controller) 30 may include an event count timer 48 that measures a velocity pulse, for example.

The first image processing device (dual-camera image controller) 30 may include a two-port (16 bit-bus: FROM/SRAM, 32 bit-bus: SDRAM) memory bus.

FIG. 8 is a diagram showing a configuration example of the second image processing device (multi-video-input interlace/progressive device or IC that converts an interlaced signal into a progressive signal) according to this embodiment.

The second image processing device (multi-video-input interlace/progressive device or IC that converts an interlaced signal into a progressive signal) 20 is an IC that converts an interlaced signal into a progressive signal. Since the second image processing device (multi-video-input interlace/progressive device or IC that converts an interlaced signal into a progressive signal) 20 includes an SRAM 130 sufficient to convert an interlaced signal into a progressive signal, the second image processing device 20 can convert an interlaced signal into a progressive signal without using an external RAM.

The second image processing device (multi-video-input interlace/progressive device or IC that converts an interlaced signal into a progressive signal) 20 has four video input channels 22-1, 22-2, 22-3, and 22-4, and can perform various types of picture output (e.g., fixed picture output, auto scan picture output, and multi-input merging picture output). The second image processing device (multi-video-input interlace/progressive device or IC that converts an interlaced signal into a progressive signal) 20 according to this embodiment has a moving body detection function, and can issue an interrupt to a host CPU when the second image processing device 20 has detected a moving body. Therefore, the power consumption of the system can be reduced.

The second image processing device (multi-video-input interlace/progressive device or IC that converts an interlaced signal into a progressive signal) 20 includes input controllers 110-1 to 110-4 that control the input timings of image data through the channels 102-1 to 102-4. The second image processing device (multi-video-input interlace/progressive device or IC that converts an interlaced signal into a progressive signal) 20 according to this embodiment includes scalers 110-1 to 110-4 that resize image data output from the input controllers 110-1 to 110-4. In the reduction mode or the merging mode, the scalers 110-1 to 110-4 reduce the number of pixels of each line of the input image by half to reduce the length of the data row by half.

The second image processing device (multi-video-input interlace/progressive device or IC that converts an interlaced signal into a progressive signal) 20 includes a memory controller 140 that writes outputs from the scalers 110-1 to 110-4 into the SRAM 130, reads image data from the SRAM 130 at a predetermined timing, and outputs the image data to a first output line 163, a second output line 165, and a third output line 166.

The second image processing device (multi-video-input interlace/progressive device or IC that converts an interlaced signal into a progressive signal) 20 includes an I/P conversion section 170 that receives the image data through the first output line 163, the second output line 165, and the third output line 167, and outputs progressive image data.

The second image processing device (multi-video-input interlace/progressive device or IC that converts an interlaced signal into a progressive signal) 20 includes an area sensor 120 that performs moving body detection and brightness detection, and an interrupt controller 122 that generates an interrupt signal based on the moving body detection result and the brightness detection result.

The area sensor 120 functions as a brightness change detection section that integrates the pixel values or pixel components relating to luminance of at least some pixels of the received image data in each frame to calculate an integrated value, compares the integrated value with a given comparison target value, and detects a change in brightness of the image in each frame based on the comparison result.

The interrupt controller 122 functions as an interrupt control section that generates an interrupt signal when a change in brightness has been detected.

The second image processing device (multi-video-input interlace/progressive device or IC that converts an interlaced signal into a progressive signal) 20 includes an I2C 190, an I2C through controller 192, and a selector 194.

An I2C processing section 58 of the first image processing device (FIG. 7) that has received the interrupt signal generated by the interrupt controller 122 sets the imaging control parameter of the digital camera through the I2C 190, the I2C through controller 192, and the selector 194 of the second image processing device, for example.

3. Microcomputer

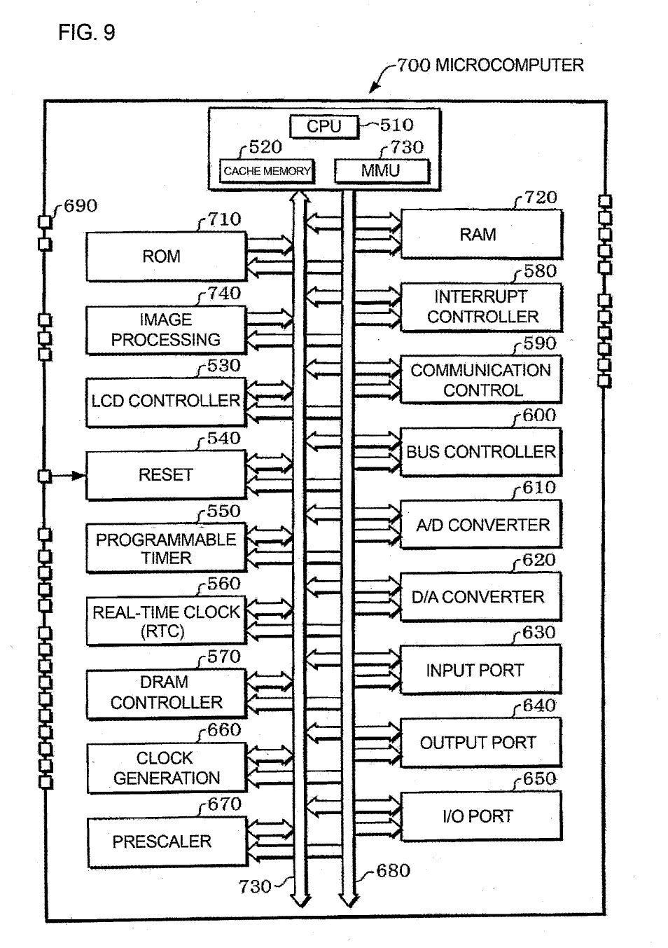

FIG. 9 is a hardware block diagram showing a microcomputer according to one embodiment of the invention.

A microcomputer 700 includes a CPU 510, a cache memory 520, an LCD controller 530, a reset circuit 540, a programmable timer 550, a real-time clock (RTC) 560, a DRAM controller/bus I/F 570, an interrupt controller 580, a serial interface 590, a bus controller 600, an A/D converter 610, a D/A converter 620, an input port 630, an output port 640, an I/O port 650, a clock signal generation device 560, a prescaler 570, an MMU 730, an image processing circuit 740, a general purpose bus 680 and a dedicated bus 730 that connect these sections, various pins 690, and the like.

The image processing circuit 740 has the configuration described with reference to FIGS. 1 and 3, for example.

4. Electronic Instrument

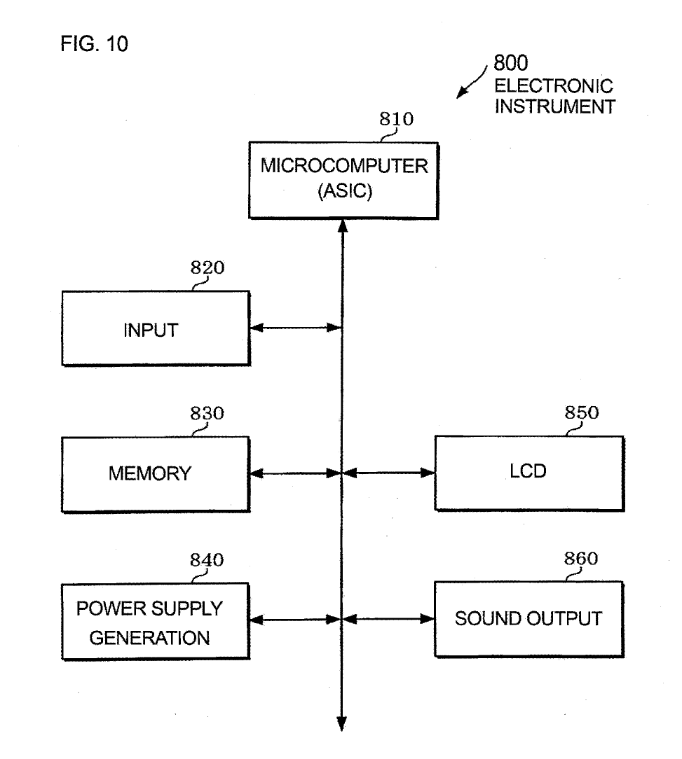

FIG. 10 is a block diagram showing an example of an electronic instrument according to one embodiment of the invention. An electronic instrument 800 includes a microcomputer (or ASIC) 810, an input section 820, a memory 830, a power generation section 840, an LCD 850, and a sound output section 860.

The input section 820 is used to input various types of data. The microcomputer 810 performs various processes based on data input using the input section 820. The memory 830 functions as a work area for the microcomputer 810 and the like. The power supply generation section 840 generates various power supply voltages used in the electronic instrument 800. The LCD 850 is used to output various images (e.g., character, icon, and graphic) displayed by the electronic instrument 800. The sound output section 860 is used to output various types of sound (e.g., voice and game sound) output from the electronic instrument 800. The function of the sound output section 860 may be implemented by hardware such as a speaker.

The invention is not limited to the above-described embodiments, and various modifications can be made within the scope of the invention.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An image processing device that receives pixel-unit image data in a plurality of frames in time series and performs image processing, the image data being captured by an imaging section, the image processing device comprising:
a brightness change detection section that integrates pixel values or pixel components relating to luminance of at least part of pixels of the received image data in each of the frames to calculate an integrated value, compares the integrated value with a given comparison target value, and detects a change in brightness of an image in each of the frames based on a comparison result.

2. The image processing device as defined in claim 1,
the brightness change detection section integrating Y components of at least part of the pixels of the received image data to calculate a Y component integrated value, comparing the Y component integrated value with a given comparison target value, and detecting a change in brightness of the image in each of the frames based on the comparison result.

3. The image processing device as defined in claim 1,
the brightness change detection section dividing the image in each of the frames into a plurality of areas, integrating the pixel values or the pixel components relating to luminance of the pixels of the received image in each of the frames for each of the areas to which the pixels belong to calculate an integrated value for each of the areas, and detecting a change in brightness based on the integrated value for each of the areas.

4. The image processing device as defined in claim 1, further comprising:
an imaging control section that performs control for changing a parameter of the imaging section relating to an image luminance adjustment when a change in brightness has been detected.

5. The image processing device as defined in claim 1, further comprising:
an interrupt control section that generates an interrupt signal when a change in brightness has been detected.

6. The image processing device as defined in claim 1,
the brightness change detection section setting or changing the comparison target value based on integrated value historical information.

7. The image processing device as defined in claim 1,
the brightness change detection section setting or changing the comparison target value based on date information.

8. The image processing device as defined in claim 4,
the brightness change detection section setting different comparison target values corresponding to a plurality of levels, comparing the integrated value with each of the comparison target values corresponding to the levels, and determining a level of a change in brightness based on a comparison result; and
the imaging control section performing control for changing an image recognition parameter of the imaging section based on the determined level.

9. The image processing device as defined in claim 8,
the imaging control section storing a level control table, the level control table storing camera module control patterns corresponding to the levels, the imaging control section performing control corresponding to a level determined based on the level control table.

10. The image processing device as defined in claim 1,
the brightness change detection section thinning out the pixels in each of the frames according to a predetermined rule when integrating the pixel values in each of the frames, and integrating the pixel values of the remaining pixels after the thinning.

11. A microcomputer comprising the image processing device as defined in claim 1.

12. A microcomputer comprising the image processing device as defined in claim 2.

13. A microcomputer comprising the image processing device as defined in claim 3.

14. A microcomputer comprising the image processing device as defined in claim 4.

15. A microcomputer comprising the image processing device as defined in claim 5.

16. A microcomputer comprising the image processing device as defined in claim 8.

17. An electronic instrument comprising:
the microcomputer as defined in claim 11;
an input section that inputs data to be processed by the microcomputer; and
an LCD output section that outputs the data processed by the microcomputer.

18. An electronic instrument comprising:
the microcomputer as defined in claim 12;
an input section that inputs data to be processed by the microcomputer; and
an LCD output section that outputs the data processed by the microcomputer.

19. An electronic instrument comprising:
the microcomputer as defined in claim 13;
an input section that inputs data to be processed by the microcomputer; and
an LCD output section that outputs the data processed by the microcomputer.
